(19) United States
(12) Patent Application Publication
(10) Pub. No.: US 2010/0082416 A1
(43) Pub. Date: Apr. 1, 2010

(54) Subcred

(76) Inventor: Lee Blackman, Brooklyn, NY (US)

Correspondence Address: Lee Blackman, 601 Park PL, Brooklyn, NY, 11238, US

(21) Appl. No.: 12/586,295

(22) Filed: Sep. 21, 2009

Related U.S. Application Data
(62) Division of application No. 10/389,594, filed on Oct. 21, 2003.

(51) Int. Cl. G06Q 40/00; G06Q 20/00; G06Q 30/00; G06Q 50/00

(52) U.S. Cl. 705/14.17; 705/38; 705/34

(57) ABSTRACT

A method and system for subscribing credit using subscribing credit plans wherein user choose a subscribing credit plan with a limited working life one to three years then apply for the service plan chosen. If approved subscriber is required to deposit up to ten percent of the service plan depending on the lender, pay an activation fee and or a monthly subscription fee in order to have access and use the credit amount applied for. There is no accruing interest on outstanding balance or deposit made to start an account. A lender may offer extra credit as a bonus in exchange to add interest on the outstanding bonus balance or it is subject to accrued interest, when part or whole bonus is used. Payment on outstanding balance over $50 is 2%-5% minimum, balance $50 and under is 25%-50% plus the subscribing fee.

### CROSS-REFERENCE TO RELATED APPLICATIONS

This Is A Division Application

U.S. patent Ser. No. 10/389,594 filed on Mar. 12, 2003
U.S. patent No. NONE

### STATEMENT REGARDING FEDERALLY SPONSORED RESEARCH OR DEVELOPMENT

This invention is not associated with any federally sponsored research or development.

### BACK GROUND OF THE INVENTION

1. Field of the Invention

Present invention relates to credits, particularly credit card and cash advance check. More particularly, the invention relates to a method and system for subscribing credit plans with a four-digit credit card using a personal web template and or that can use three to ten digits of the account number or three to ten digits assign to the account number to or that accesses a paperless electronic checking account and or other financial account.

2. Description of the Related Art

Present invention relates to various lines of credit. Present Credit card issuers do not have subscribing credit plans to choose from, without accruing interest on outstanding balance. Cash advance check is loaded with high interest than a regular credit card purchase. Credit card and checking account number can be easily stolen from a check or card in person and on the Web. Some personal line of credit requires the borrower to write checks from the line of credit account to be deposit into a separate account every time funs are needed from the line of credit. Zero (0%) APR introductory rate on credit card, only applied to new accounts and balances transfer. Introductory rates are none renewable and account must be in good standing during the introductory period, if not, the account holder will pay higher interest rate. The use of cash advance checks are limited because of the expiration date, and although paper checks are used to convert into electronic checks, it does not produce or allowed the payer to have a copy of any kind when a check is deposited or after it has been mail to a payee. Check number and amount cannot be lock or unlock by the account-holder. With an e-check or electronic check conversion, the complete paper check is scanned in order to become an electronic check. Paperless electronic check template with an electronic check or (digital) check with payer signature and or an electronic checkbook activated by a card or a card used to access a check in a checking account is not in current use. Payment received on outstanding balance on traditional credit account goes towards the first purchase or use of the credit, (first in first out) unless stated in writing by the payer. Interest Payment on outstanding balance varies with the daily periodic rate (DPR) unless it is a 0% APR introductory fix rate on with the current credit card system.

### BRIEF SUMMARY OF THE INVENTION

It is an object of the present invention to provide a method and system for Subscribing credit, that would enhance the personal credit industry; by making credit more affordable and turning credit into an every day purchase product over the counter that would revolutionizing the way in which credit is establish and distributed to consumers. Subscribing credit (Subcred/Credsub) or Lee Financial Economical Enhancement (Lfee) are sold in credit plans to the average consumer and comes in two flavors, checking (Lfee check/Subcheck) which is a paperless electronic check or decoy check (Dcheck) and a credit card (Lfee card). Each one can be used independently with its own features and tools or bundled. Subscribing credit comprise of a lender issuing subscribing credit plans with a master/primary financial account number to a subscriber (lender's subscriber) or one who subscribe to a lender in exchange for a subscribing loan, using a subscribing credit plan with a four (4) digit credit card number or using 3 to 10 digits of the master/primary financial account number or an assign three to ten digit numbers to the account (financial account) to over come the short fall of the prior art. The four (4) digit credit card number or 3 to 10 digits of the master/primary financial account number or an assign three to ten numbers to the account are issued as an iip card or slave numbers and reside and or sheltered at the agent or distributor place of choice for custody on agent or distributor computer network with subscribing credit plan software, financial calculating software and access through a web payment gateway terminal or regular payment gateway. A user subscriber access the agent or distributor Internet payment gateway by user a computer or other device that is internet enable for subscriber user to insert the slave numbers onto the Internet payment collective page gateway terminal or by using a web payment gateway terminal with a subscribing financial account card. The used four digit or three to ten numbers of the account number or assign number(s) is/are displayed conforming the transaction. The four digit credit card number(s) is/are slave(s) number(s) to a master/primary financial account number issued by a lender, and sheltered or reside at the issuer and or an agent or distributor. Another object of the present invention is to provide a method and system for implementing several different subscribing credit plans to choose from, a personal financial web template, a payment number (PYN/USFIN) that is static on the user web template, or the four-digit credit card number or used 3 to 10 digits of the financial account number and or an assign number can be voluntary entered on the web template. The said four or three to ten digit can only be used by an account holder, to making secure web transaction using a personal Software dialer/connecter to connect to a network transaction template (ecommerce payment gateway). Subscribing credit plans are used for credit card and Lfee checking account line of credit, bundled with conventional checking to form a single account (Lfee account/Lfee checking account). Subscribers can choose a credit plan with or without accruing interest on outstanding balance, with limited or unlimited life e.g. a working life of 1-3 years (3Tcredit) with a renewable process. An issuer or agent/distributor that sheltered or reside the lender subscriber master/primary financial account number at its place of choice in exchange for issuing four digit slaves numbers (iipcard/iipcard numbers) or account to a subscriber to a credsub/Lfee user, can also activating a Credsub (Subcred) account. The four digit credit card slave numbers (iipcards) internet instant payment cards or instant internet payment cards are used for internet transaction. When an agent or distributor of the iip card (slave) four digit numbers, is different to that of the lender, then the lender subscriber (user) would have to apply to an iipcard agent or distributor of the up account. The slave (iip) numbers are distributed on loose paper cards or tear off from a set; when all the slave numbers are used on a card, the user move's on to another card. If and when a Credsub/Lfee applicant has an existing credit card or other credit account with the issuer and such credit account is in good standing, no income check is required on or for the said applicant applying for the credit account; as a bonus when issued as a standalone credit card and or other credit account, the said issuer would march at lest part of the Credsub credit line with applicant existing or current credit line. The four digit credit card number or three to ten numbers of the account number or an assign three to ten numbers to the/a financial account (iip slave numbers) can be architecture on a storage device that can be place inside, or affix onto a compact portable hand held digital device; the said portable digital device display four digit credit card number(s) and or three to ten numbers of the account number or an assign three to ten numbers to the/a financial account when activated for use by a user. The said device also carry's a system calculator and clock for registering the date and time when a four digit credit or three to ten numbers (slave) number been used. Checks can be pre written e.g. not valid over $500 or outside the U.S.A. When part of a credit card account is bundled with or used to open a Lfee account, it may reduce the credit card credit line or can be as a standalone credit card depending on the Lender. Credsub account can be architecture to link with a regular credit card account e.g. when used with an existing credit card or other account and a credsub checking account or cash advance checking account, if you write a check for $100 and your account has a $25 balance. The issuer will pay the other $75 or $100 and charge it to your conventional credit card to avoid returned or bounce check. You will be bill by your credit card issuer each time for such service as purchases, not cash advances. Lfee check comes in two flavors, paper checks and paperless electronic check. The Lfee paperless Electronic Check(s), is/are access by the paperless electronic check card (PEC card). If the card or hidden numbers under the magnetic stripe on the card are in working order, the end user electronic checkbook data base would automatically be access awaking the (Sleepy Check/Lazy Check) from its sleep and retrieve it, then display the sleepy check or decoy check number that is not yet published will be retrieve, with the user or accountholder electronic photo and or signature, displaying a paperless electronic check automatically on the cashier's screen or convenient universal payment machine (CUPM). The paperless Electronic Checks numbers does not run in chronological order. When a check is process and approved, it print's the check in the form of a receipt, with the same check number that displayed on the CUPM and or with a line for the payer's signature. Lfee check is a paperless Electronic Check; that is access with a card and distributed with a checking account line of credit and or bundled with conventional checking to form a single account. There is no deposit require to cover written checks unlike traditional checking account. Checks are certified without using a bank teller or entering the bank. There is no credit increase with Credsub (Lfee) line of credit year after year unlike conventional credit card line of credit. Even if the account is a credit card account. Credit is increase by purchasing higher plans, if qualify. Payment on outstanding balance over $50 is 2%-5% minimum, balance $50 and under is 25%-50% minimum. Payments can be made with any lender that issue Credsub (subcred) account using a Cpay slip and your PYN/USFIN. PYN (Payer number): is a special standardize number (ID) or USFIN (Universal Standardize Financial Identification Number). The number is use with financial transaction or identity theft account (ITA) e.g. Credit cards and mortgages. There is no first in first out payment on outstanding balances and accruing interest on outstanding balance. However, cash advance and bonuses are subject to accruing interest and first in first out payment. Checks or financial cards can be lock and unlock by the payer, to prevent access to his cash and credit account and or prevent checks from being cleared by using Checkact. Credsub account does not carry a publish account number unlike conventional credit cards or checks. It uses a PYN/USFIN as a public number, which links it to the account number. The PYN will also be on paper checks replacing the account number. Checks written on the account is not subject to cash advance fee or transfer fee. Credsub credit debt can be sold by the accountholder, but account holder is required to pay previous credit holder/lender a fee. Fee may not exceed three (3) % of the total credit amount or service plan debt. Using such methods or assigning such methods to a financial account by a lender, agent or distributor for the sole purpose of paying only utility bills, mortgages, rent (Land lord); credsub method is credit on the cutting edge (COTCE). A percentage of all purchase made will be put aside as a bonus (purchase bonus). At the end of each term, if there is an account balance, it will be used as a payment towards the account, if there is no outstanding balance, it becomes void automatically if not used within a given time or period by account holder. The foregoing and other objects, features, and advantages of the invention will be visible from the following description of preferred drawings of the invention as illustrated in the accompanying drawings.

### BRIEF DESCRIPTION OF THE DRAWING

FIG. 101 is a diagram showing a Lfee paper check (Subcheck) without a magnetic stripe.

FIG. 102 is a diagram showing a magnetic stripe covering the Routing number (Transit number) on a paper check.

FIG. 103 Is a diagram showing a paperless electronic check.

FIG. 104 is a diagram showing a Cpay slip.

FIG. 105 is a diagram showing multiple bundled service plans.

FIG. 106 is a diagram showing multiple service plans for credit card and checking account.

FIG. 107 is a diagram showing multiple Service plans with deposit requirement.

FIG. 108 is showing multiple service plans with limited and unlimited life.

FIG. 109 is a diagram showing the view of Lfee (Subcheck) when it becomes an Escrow check.

FIG. 110 is a diagram showing multiple bundled Service plans carrying a fix amount.

FIG. 111 is a diagram showing a Lfee software template dialer/connecter dialog box.

FIG. 112 is a diagram showing a utility payment web template with a dropdown menu.

FIG. 113 is a diagram showing a utility payment web template listing all of the end user utility suppliers.

FIG. 114 is a diagram showing part of the sing up process for user name and address.

FIG. 115 is a diagram showing part of the sing up process for future Internet utility payment accounts.

FIG. 116 is a diagram showing a blank decoy check.

FIG. 117 is a diagram showing payee information entered on a decoy check.

FIG. 118 is a diagram showing a decoy check ready to be paid.

FIG. 119 is a diagram showing a payee depositor decoy check ready to be deposit.

FIG. 120 is a diagram showing a use or subscriber personal financial web template.

### DETAIL DESCRIPTION OF THE INVENTION

Referring now, more particularly, to the drawings, indicate the structural features in the various diagrams and service plans with a method and system for subscribing credit, where by someone can lease credit and purchase higher credit service plan with limited life or unlimited life e.g. 3 years (term life credit), without interest on outstanding balance.

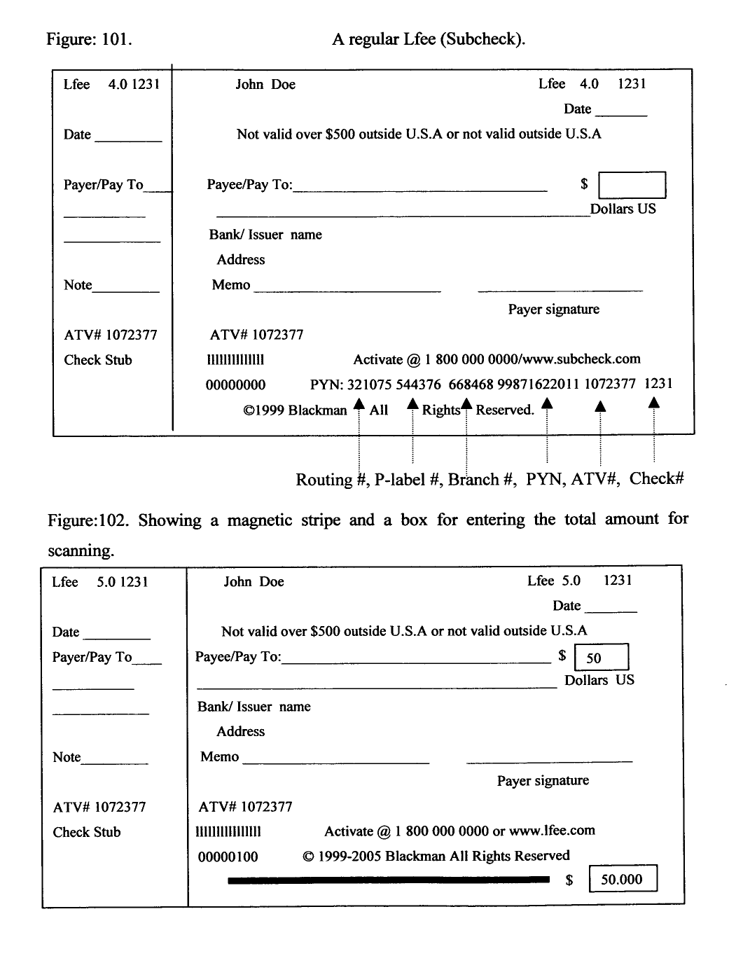

FIG. 101 is a diagram showing a Credsub check (credit subscribing check) or Lee Financial Economical Enhancement (Lfee) paper check (Subcheck) with a routing number (transit number), PYN/ID # 3210 75 668468 99871622011, activated (ATV) number, check number and UPC number. The diagram also shows where to activate the check if needed and not valid over $500 and or outside the USA. Each one can be used independently with its own features and tools or bundled. Credsub paper check does not carry a publish account number that can be viewed on the check unlike conventional checks. It uses a PYN/USFIN as a public number, which links it to the account number. The PYN will also be on paper checks replacing the account number. Checks written on the account is not subject to cash advance fee or transfer fee. Lfee check (subscribing check) is a check that is paid of a subscribing credit checking account that do not required the account holder to make any deposit in his account for the check to be drawn against it during the Tcredit (term of the credit) or working life of the account. The check bears the holder's name without his street address as an extra security. Each serial and ATV number would be different and does not run in numeral order unlike check numbers. Lfee check comes in two flavors, paper check and paperless Electronic Check, with a Checking account line of credit or a conventional checking account joint with a line of credit to form a single account. Example, when you are approved for a line of credit to open a Lfee account, you are required to make a deposit e.g. $5 or one to ten percent (1%-10%) of the approved credit line in order to start the account. There is no minimum balance required in the account. All payment received on outstanding balance will be credited to the Lfee account. Lfee account also comes with zero accruing interest with a limited life e.g. one to three (1 to 3 years) or unlimited life. Whenever there is an outstanding balance on the account at the end of the term; the Issuer or lender would use part or whole deposit to pay off outstanding balance.

FIG. 102 is a diagram showing how Lfee paper check work: To make a purchase with a paper check, the payer will write the payee name, amount of the purchase and add his signature on the check. Depending on the version, he will write the amount in the box at the bottom next to the magnetic stripe for scanning or at the top as shown in FIG. 101 When the check is scanned, the routing number (ABA number), branch number or private labeler number, PYN, serial/ATV # number, check number under the magnetic stripe and the cash amount written at the bottom of the check are scanned from the magnetic stripe. If the amount written or numbers cannot be scanned, the cashier would enter the amount and or the numbers manually, then press enter to retrieve the payer's electronic signature and photo from the database where it has been stored by the account issuer during the application process. It will automatically appear or display on the check image on the line next to payer signature on the cashier's screen (CUPM). The payer has an option of entering his PIN number. The payer can also use a signature pad, then press enter. When enter is press, it will send the signature from the pad onto the check image on the screen, making it a completed check with a signature. The Cashier will press enter to send the information entered onto the electronic check image of the paperless Check electronically to the merchant Bank for processing. The check guarantee processor will also have an electronic check Image apparatus to receive the paperless electronic check information from the merchant. The date, time, payee name and merchant (payee) and or Licensee number, would automatically appear on the image of the check guarantee processor. The cashier will stamp the merchant's name on the used check, or place the check into the receipt printer to be printed with the word Void or used, then given back to the payer. A Lfee subscriber can use Checkact, a security feature (process) that act as a key to lock and unlock a check or financial card allowing it to have access or from gaining access to the cash/credit in an account. Using a PYN, serial or ATV number on a Lfee card or check, to allowed a check/card number and total amount that is on the card or written on the check, to make available when the card or check is used (deposited). Or make the cash/credit available for the specific card/check number to be used or drawn against or cleared. By using this security feather or process, in case the check/card is loss or stolen, no one will have access to your cash or credit. The payer himself will be doing most of the activities, instead of the bank/lender. A cash amount must be entered in order for a check or card to be activated e.g. $50. If $60 is activated and only $50 is used the other $10 would automatically remain in the account and a fee may apply (returned or unused fee). The account holder address is optional on the check. When altered it gives the check an additional security boost. To activate a card/check or bring it to life, you must enter the PYN/USFIN# or Account number, ATV/serial number, card/check number, and the cash amount you want to put or allowed on the card or write on the check depending on the type, your PIN/Id number and or zip code using a phone, CUPM, ATM or the web and press enter. Checkact can be architecture in a way that when activated you can receive an activated number. When a check/card is activated the total amount activated will automatically be subtracted from the account e.g. an account balance of $60 with an activated $50 will leave the account with a $10 balance. The $50 will be unavailable fun because it moves to perform a transaction that is not yet paid for.

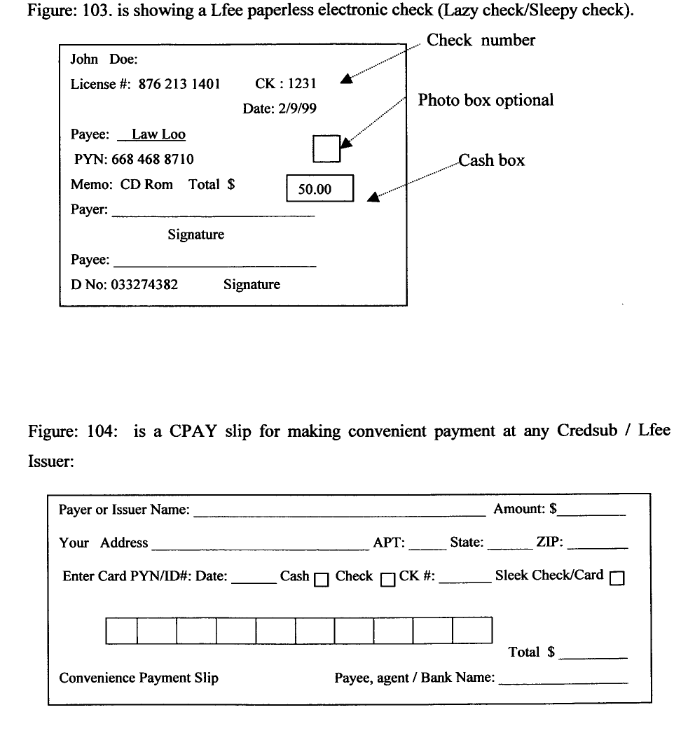

FIG. 103 Is a diagram showing how Lfee Paperless electronic check (ID/Lfee check card/LfeeCC) works: By scanning the magnetic tape on the Lfee ID card and pressing enter or send or by scanning a paperless electronic check (PECheck) with a magnetic stripe; awaken Sleepy Check (Lazy Check) to process the hidden numbers on a convenience universal payment machine (CUPM) after it prompts and display the paperless electronic check (Lfee check) on the check template on the CUPM display a. If the hidden numbers under the magnetic stripe are in working order, the end user electronic checkbook data base would automatically be access and a check number not yet published will be retrieve, with the user electronic photo and or signature, displaying on the check or long side the paperless electronic check automatically on the cashier's screen or convenience universal payment machine (CUPM). Awaking the sleepy check (Lazy Check) from its sleep. When process and approved, it print's the paperless electronic check (PECheck) in the form of a receipt, with the same check number that was displayed on the CUPM, and or with a line for the payer's signature as a form of accepting the transaction. Lfee paperless electronic checks (PEChecks) numbers does not run in numeral or chronological order unlike regular conventional checks e.g. 1012, 1013, and 1014, but can be optional. FIG. 103 also shows a used paperless electronic check image on the check issuer or bank system with the payer and or depositor signature, account number that the PEcheck deposit on example D No: 033274382 and amount of the check. Lfee check can also be custom tailored for private labeling (private labeled check/PLC), with an advertiser name on the (PECheck) card next to the issuer or lender. Lfee can also be use as a universal personal or business check Gcheck or GOcheck (Global check).

FIG. 104 is a diagram showing a Cpay slip for making payment at any Credsub/Lfee issuer using a Payer number (PYN) which is a special standardize number (ID) or USFIN (Universal Standardize Financial Identification Number) that identify an individual anywhere in the world using Credsub or Disposable Financial Tools (DFT). It is use for financial transaction only e.g bank deposits, payment on credit accounts, loans and mortgage etc or Identity theft account (ITA). The payee PYN will be on the back of a deposited check and the payer PYN will be in front, replacing the account number. That will prevent the payee and payer from seeing each other account number, in order to avoid check fraud. ATV Number: is a number used for activating checks or financial card. Convenience Payment/CPAY: is a slip used at a financial institution for making payment on a Lfee account to any Lfee issuer for a fee equaling an ATM charge. As shown in FIG. 104. Credsub debt can be sold by the account holder, but account holder is required to pay previous credit holder/lender a fee. Fee may not exceed three percent (3%) of such debt. Using such methods or assigning such methods to a financial credit account, for the sole purpose of paying utility bills, mortgages, rent (Land lord) or other payee with Credsub method is credit on the cutting edge (COTCE).

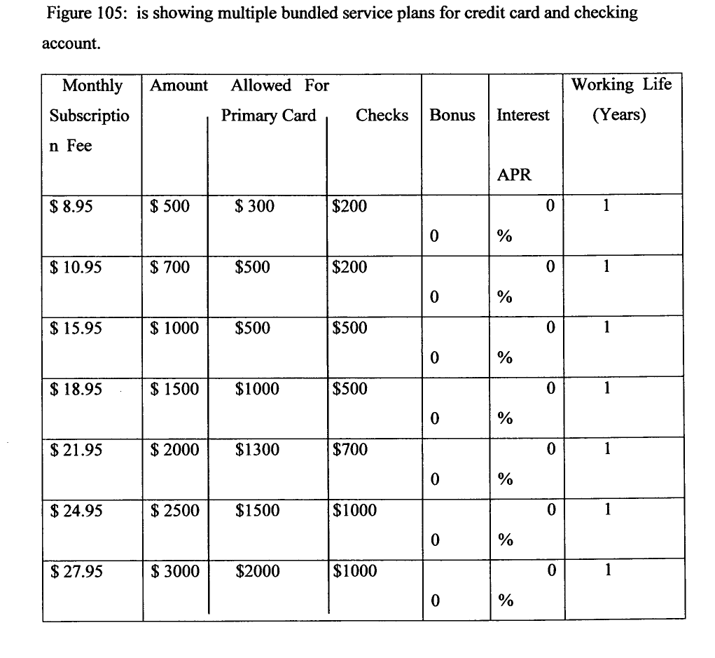

FIG. 105 is a diagram showing multiple bundled service plans with a fix amount for credit card with checking, with 1 Tcredit (one year), 0% APR and zero bonus.

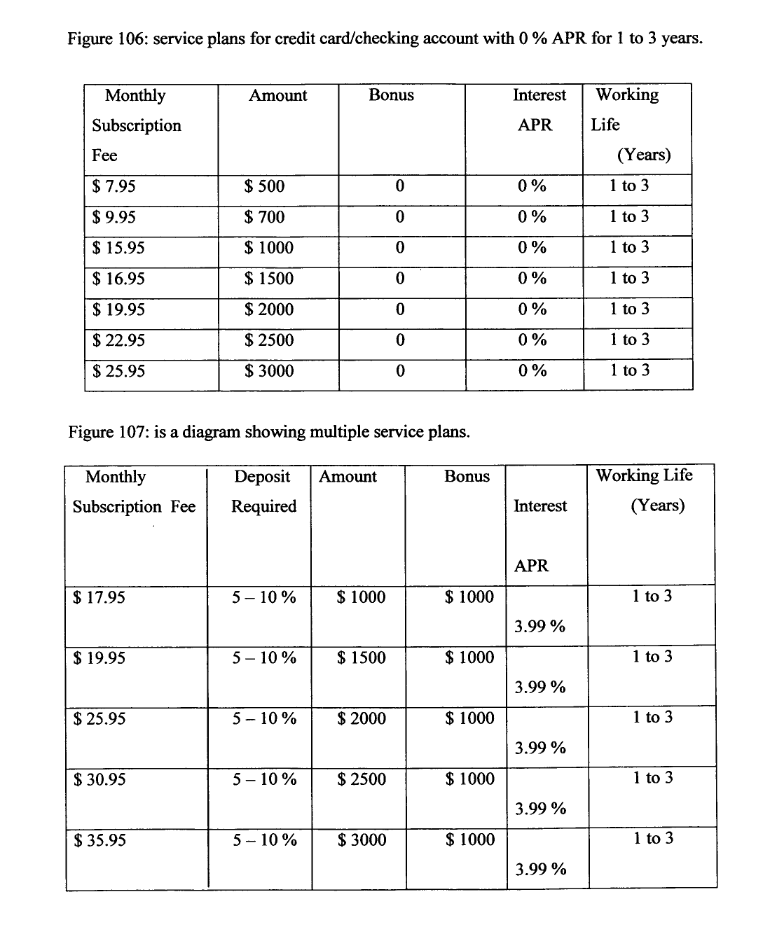

FIG. 106 is a diagram showing multiple service plans with 1 to 3 Tcredit, for credit card or Lfee checking account, with 0% APR and zero bonus.

FIG. 107: is a diagram showing multiple Service plans that can be use for credit card or Lfee checking account, deposit required and working life 1 to 3 year (Tcredit), bonus access at 3.99% APR and deposit required.

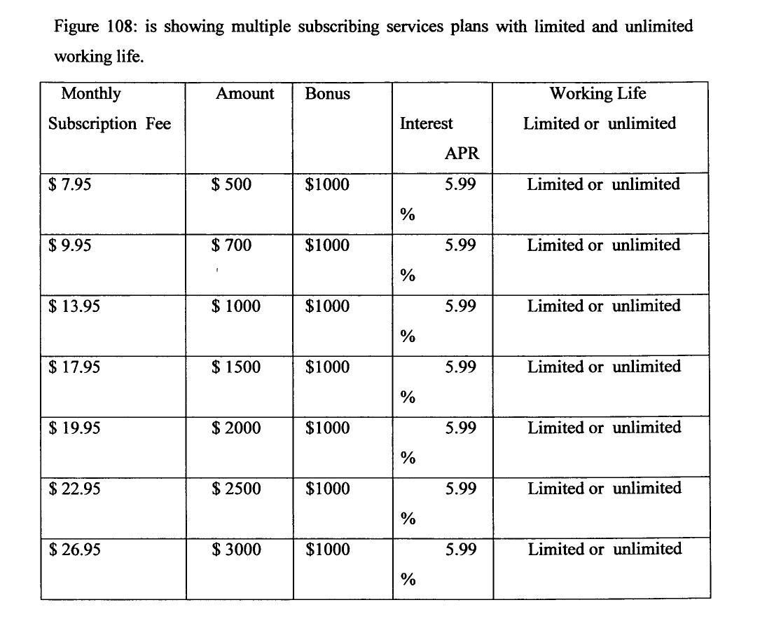

FIG. 108 is showing multiple service plans that can be used for limited and or unlimited life, with bonus and 5.99% APR, for Lfee checking account and or credit card with cash advance check for the entire amount.

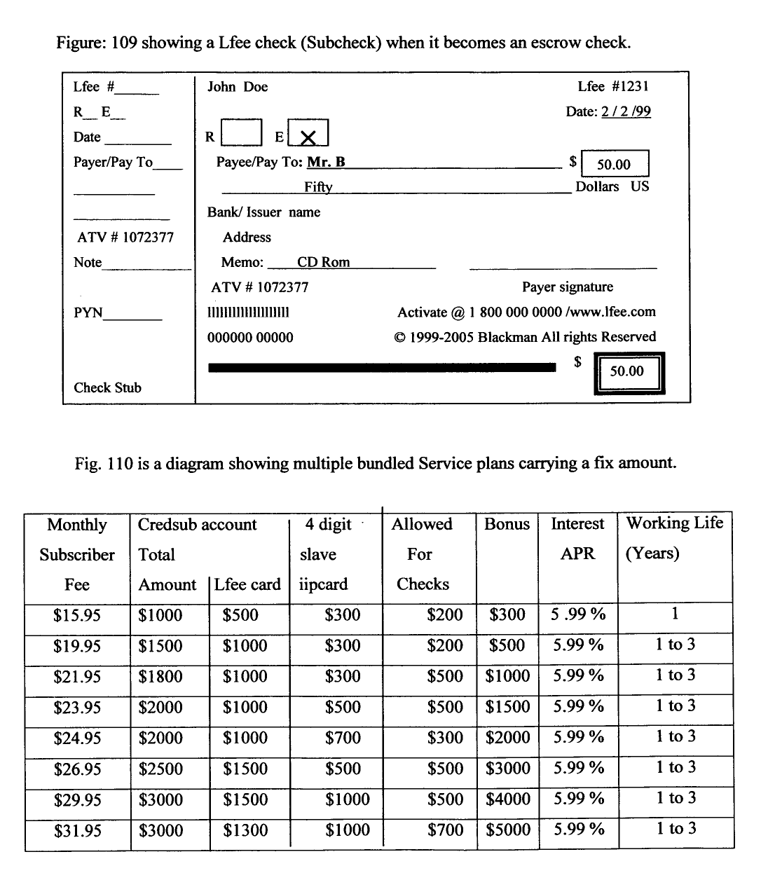

FIG. 109 is a diagram showing a Lfee Escrow Check (Certified Check) or Early Deposit Check (EDCheck), or an instant deposit check (ID check); that is use with an advance feature or process on a CUPM or PAWT (portable automated web terminal), that add or display the Lfee instant deposit check (paperless electronic check or PECheck)) on a CUPM, allowing an account holder to certified their own checks, without using a bank tellers or entering the bank, to deposit checks, and or without having an actual paper check in your position, seeing it, endorsing it; in front of the bank teller in order for the check to be deposited. Check the financial status of the amount on the check or find out if the check is activated using the PYN number, serial/ATV number, check number and the total cash amount written on the check; without putting your feet in front of the bank. A bank account is needed and access to one of the following, CUPM, phone, web, ATM or credit card machine; and just follows the prompts. Escrow check works with Checkact (Check activation. Escrow Check (Certified Check) cannot be cancel by the payer. It is a process by which a bank or issuer moves funs from a Lfee or subscribing credit account for or as future payment to a third party account. If the third party does not deposit the check within a given period e.g. 21 days from the date the escrow started, the escrow will be reverse into the holders account and a service fee/penalty apply for moving the funds (2 ways, 3^{rd} party only). The payer and the payee will be charge a onetime service fee when the check is deposited. Payer, purchase fee, payee transfer/deposit fee, both fees would be the same amount. Or they both can be enrolled or subscribe to Checkact and or escrow service. Escrow monthly service fee or escrow fee is a monthly subscription service access fee, charge by a Lfee or credsub issuer to be on the Escrow (early deposit) network, to allow an account holder to Certify his own checks and deposit Escrow checks and or other checks. An account holder must subscribe to the Escrow and Checkact network in order to have access to those features for the process to take place. An escrow check works with a CUPM, PAWT and or subscriber user login in to his account on the web, using a unique name and a Pin number (optional). A payer make said check available to payee on the web mean the written check deposit date is not later than the date it was written is a check certified by the account holder himself without using a bank teller A payer can also write a paper check, with the payee name, amount, date, and add payer signature after writing the check; he will scanned the check for the automatic paperless electronic check to popup, with the same amount and check number or he can enter the amount manually depending on the version. A payer can also used his LfeeCC (Lfee or credsub check card) and scanned it or allowed his CUPM to capture the banking information on the card, then press enter to access the electronic checkbook data base to display a paperless electronic check automatically on his CUPM with a check number not yet published and the payer's signature as shown in FIG. 103. The payer would enter the amount paying with the payee PYN or USFIN/License number, payee name, memo and press post/enter. If approved, e.g $50, a receipt will be printed in the form of a check as shown in FIG. 103, with the check number, payee name and the $50 amount for the payer to sign as an option or print with the payer signature. When send/enter button is press, the check would go to or enter onto a payee CUPM with the PYN or USFIN/License number that the payer entered on the check. The payee CUPM would be notify with a ring, light signaling or sound as an option. When the check is delivered, the payee CUPM will display the check number and amount with the payer signature on the line mark payer signature as shown in FIG. 103. The issuer would removed the total amount of the check ($50) from the payer (Mr. A's) bank account or make $50 as unavailable fun to the payer (Mr. A) until the payee (Mr. B) deposit the check within a given period, The payee would access his CUPM in order to deposit the received paperless electronic check. By pressing or touching the deposit button on the CUPM: all received check would be displayed with check number and total amount on the digital deposit slip (DDslip) with a check mark on the side of every check. The depositor would take off the check mark from checks that he does not want to be deposit, then press or touch the deposit button to deposit the rest of the checks with the check mark. Or by following the prompts, the payee can deposit the checks by press letters and or numbers. A certified check may have the box/space C/E mark; a regular would mark R or leave blank.

FIG. 110 is a diagram showing multiple bundled Service plans with a credit card account carrying a fix amount for secondary card, checking and bonus access with 5.99% APR for 1 to 3 years. To obtain a Lfee (Credsub) account, you must choose a Lfee service plan and apply for Lfee credit or ask your credit card issuer to used part or whole credit card account to establish a Lfee account. If the Credsub/Lfee applicant has an existing credit card or other credit account with the issuer and such credit account is in good standing, no income check is required on or for the said applicant Lfee credit card account; as a bonus when issued as a standalone credit card and or other account, the said issuer would march the subscribing (Credsub) credit line with his/applicant existing or current credit line. A credit check and application processing or activation fee may apply depending on issuer. Accounts may have yearly automatic access, renewal and or an analyzing process. But if applied, a fee may also apply. Checks can be pre written e.g. not valid over $500 or outside the U.S.A, as shown in FIG. 101. When part of a credit card account is bundled with a credsub account or used to open a Lfee account, it may reduce the credit card credit line or be as a standalone credit card depending on the Lender. Lfee can be architecture to link with a regular credit card account e.g. When used with an existing credit card, if you write a check for $100 and your account has a $25 balance. The issuer will pay the other $75 or $100 and charge it to your conventional credit card to avoid returned or bounce check. You will be bill by your credit card issuer each time for such service as purchases, not cash advances and apply for the chosen plan and be approved for the Credsub (Lfee account). You can ask or use your existing credit card issuer to used part or whole credit card account to establish a Lfee account (subscribing credit account). Every account holder is required to make a deposit of one to ten percent (1%-10%) of the credit account (credit plan) and or pay a subscription fee in order to access the account or credit amount. A lender is not limited to one to ten percent (1%-10%) deposit of the service plan, but can also allowed a subscriber with zero percent (0%) down to subscribe and or used part of the approved subscribing credit amount as a deposit, activation fee and or first subscription fee for the financial account. Deposit made to start an account is none withdraw-able or accessible to the account holder, depending on the issuer. There is no accruing interest on outstanding balance or on deposit made to start an account. However a lender may offer extra credit as a bonus. Any outstanding balance on bonus amount is subject to accrued interest, when part or whole bonus is used. Accounts are setup and or activated over the counter (store front), phone and or VIA web, but not by the lenders. Every account holder is required to make a deposit and or pay a subscription fee in order to have access to for a fix amount of credit, using a Lfee (Subscribing credit) service plan as shown in the examples of FIG. 105-108 and FIG. 110. There is no accruing interest on outstanding balance or deposit made to start an account. However a lender may offer extra credit as a bonus. Any outstanding balance on the bonus amount is subject to accrued interest, when part or whole bonus is used. Payment on outstanding balance over $50 is 2%-5% minimum, balance $50 and under is 25-50% plus the subscribing fee. Accounts are setup and or activated over the counter (store front) and or VIA wed, but not by the lenders. There is no first in first out payment on Credsub accounts, because there is no interest charge to the account. Cash advance and bonuses may have first in first out payment apply. Lfee account is a none-deposit account, any deposit receive or made to the account will be treated as a payment. If the account has no outstanding balance, it would be treated as a credit towards the account. Lfee check is a Subcheck. A percentage of all purchase made will be put aside as a bonus (purchase bonus). At the end of each term, if there is an account balance, it will be used as a payment towards the account, if there is no outstanding balance, it may becomes void automatically, if not used by account holder within a given time or period.

A Lender can use in house or out house credit card to pay or link to a Credsub account. A lender that provides funs or credit for a Credsub account and used a credit card or other account issued by the same bank or lender, to pay for charges on the account. An Out house Lender: Is a lender that provides funs for a Credsub account and used a credit card or another form of payment from another issued to pay off charges on the lender's account. Lfee applicant cannot customize a fix amount of credit unlike a traditional personal line of credit. Applicant would choose a plan or the lender may assign the credit worth of a pre customize service Plans. As shown in the Lfee service Plans (subscribing plan) examples in FIGS. 105 to 108 and 110. Some plans are design for credit card and checking account. Lfee credit line does not increase unlike a credit card account year after year. However a holder may purchase additional credit by moving to a higher plan (fee optional). Lender may add accruing interest on extra amount of credit as bonus to subscriber plan. See FIG. 107.

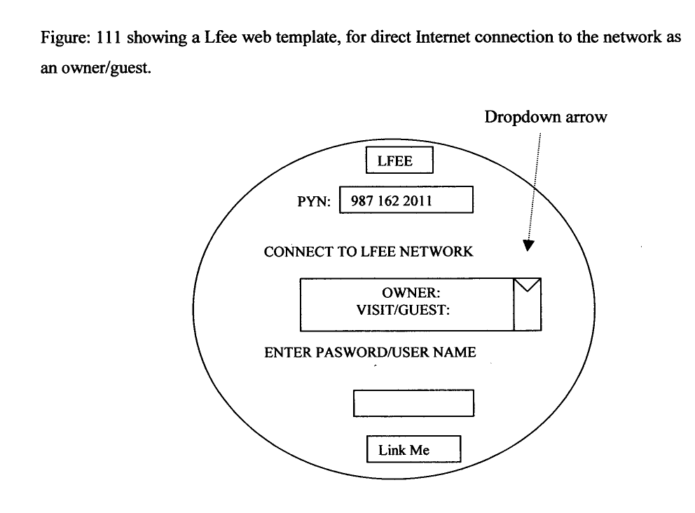

FIG. 111 is a diagram showing a Lfee software template dialer/connecter dialog box for end user input, to

make direct Internet connection to the Lfee network as the owner or visitor/guest to the computer use for
connect to the Internet, using a pass word and or PIN number.

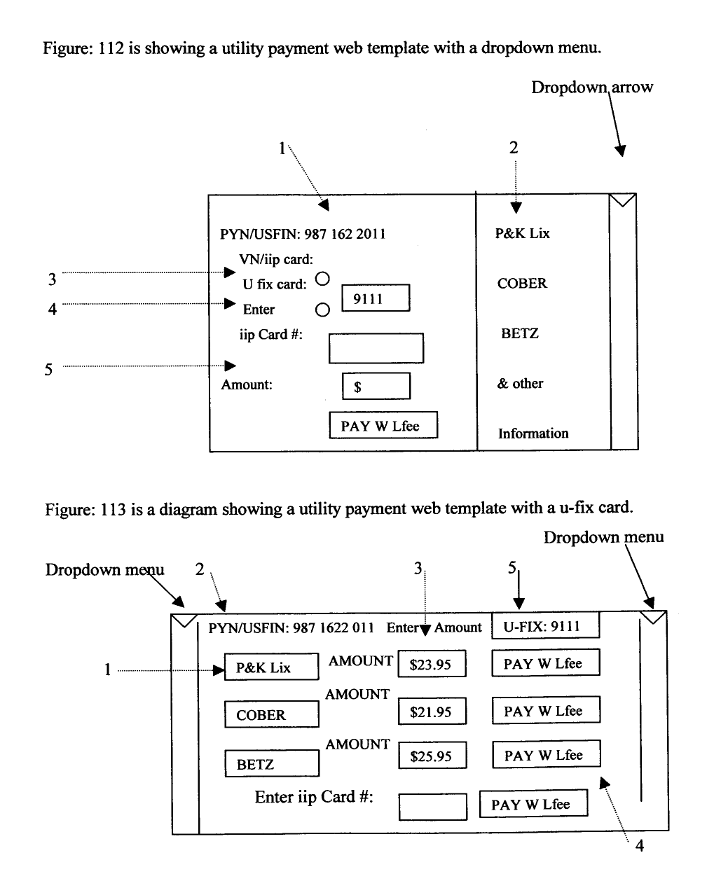

FIG. 112 is a diagram showing a utility payment web template with a dropdown menu using two different types of secondary cards on the Lfee (private) network (web site) utility payment page, with an option to choose the type of card for making payment or purchases, depending on the plan chosen. 1. Shows a PYN/USFIN: 987 162 2011 number for identifying each user payer. 2. Is displaying a dropdown menu with a list of multiple utility company or utility suppliers, mortgage company, Landlord and or other payee associated with the payer as payees. 3. Is showing a VN/iip card check box for a user payer to choose VN/iip card (slave number) of a master/primary account when paying with a VN/iipcard. 4. shows a U fix card check box for a user payer to choose when paying with a VN/iipcard. 5. is a dialog box for user payer to enter the amount paying. Is a diagram showing a utility payment web template with a u-fix/iipcard listing all of the end user utility suppliers.

FIG. 113 is a diagram showing a utility payment web template with a dropdown menu. Number 1 listing all of the end user utility suppliers (Companies) Land lord and or payee. 2. Is showing PYN/USFIN and a four digit Ufix (U-fix) card number or VNcard, when connected to the network. 3 displays a dialog box for entering the amount paying. Lfee credit card account holder or user has the option of carrying a secondary card (utility card) with a four-digit number, but can carry 3-10 digits of the account number. The secondary card comes in two flavors, a fix number (Ufix card/utility fix number) that is affix to the utility payment template as shown in FIG. 113 and voluntary number card (VNcard). Both cards are Internet utility payment cards (IUPcards). The cards feed on the primary or master account, and the primary card is used in person. But the IUPcard can be setup as a separate account, or as an extension (add-on) to conventional credit card, savings or checking account, by using the last four digits of the account number as a Ufix number, VN card or an assign 4 digit, or 3-10 digit number to an existing credit card, saving, checking or other financial account, with access to a limited amount in the account or full access to the total amount in the account as shown in FIG. 110. The utility card is designed for Internet transaction such as rent, utility bills, mortgages and Subscription payments. When used for making ISP payments or subscription payments, each payment is billed three (3) times the amount, e.g. $20 subscription will be billed $60 (quarterly billing) or. Q billing (Q bill) Mortgage card (Lfee m) is setup (issued) against the down payment on the building. How does Lfee secondary card (utility card) work: End user will use a personal software dialog box (dialog template) setup on any computer in order to log into a network web template. End user can login as the owner or visitor/guest (at home or outside). Using an assign number (PYN/USFIN) and a PIN number or password See FIG. 111. After the account is setup, end user can pay utility bills and or other payee by double clicking the Lfee personal financial software connecter (dialer icon/Link me), which will take him to the Lfee web template on the Internet to FIG. 112 or 113 depending on the service plan chosen. He will see all of his utility Landlord and mortgage suppliers or payees. The software setup package is architecture to automatically prompt the cardholder ISP dialer to connect to the Internet, directly to the network (Lfee.com). Or you can connect to the Internet with your ISP, then click the minimize button, then double click the Lfee icon. the cardholder can enter his card number e.g. #9111 (VNcard) manually or it can be static on the web template as a Ufix card. In FIGS. 112 and 113 when the words pay with Lfee/IUPcard (Pay W) followed by the payment method that is click/entered, making it an Internet instant payment card (IIPcard) it tells or go to the payee/merchant web site, that a transaction is made/paid e.g. for $23.95, on acc #987 162 2011 or with PYN/card #9111. Then it goes to the payee merchants bank, which links it to the banking systems to verify the card number and or PYN/USFIN authenticity and identify the user by matching the card number with its ABA number hidden in the background. The PYN/USFIN identify the user and the card number identity's the Lender. The card number is like a pointer or extension to the lender ABA number, when pay W is click it also prompts the respectful lender number (transit routing number or ABA #) hidden in the back ground to link with the banking systems. Making general purchase on the web: Cardholder or user will click Lfee (pay with/Pay w), followed by the payment method on the payee web site, which would prompt the Lfee personal software connecter on his computer or other Internet device to automatically popup and connect to the Lfee network. As shown on the left side on FIG. 112. Enter PYN/card number. On the right side he would see the payee name, address, PYN and Lfee license number. When Lfee card is used, merchants only have access to the four digits and or 3 to 10 digits on the card or as part of the card number (Ufix/VN card) and not the account number. Lfee account check amount is link to a conventional checking and or other financial account. A deposit is required to start the account e.g. $5 or 1 to 10% of the credit amount approved. Credsub (Lfee) account is not a 100% credit account, so there is no penalty for accounts that are transfer to such accounts. But an issuer can make a Credsub account 100% credit or credit on the cutting edge (COTCE). The account carry's zero monthly maintenance fees, and has automatic access to the amount allowed for cash advance checks and bonuses. The line of credit must be approved before making the deposit to start the account. Deposit made to start the account is none accessible unless a fee is paid or can be up to 50% of the deposit, depending on the service plan chosen and none interest bearing until the end of the term. Depending on the lender, accounts may have interest bearing as an option, but access to the deposit goes with the service plan. Making purchase with primary Lfee card in person: When the card is swipe or scanned, enter is press to process the card number. The payer photo and signature will automatically appears on the credit card machine or CUPM. After processing with the cash amount, the payer's signature receipt will be printed without his photo and signature would not be printed as an option on the payer's receipt. But the 4 digit and or 3 to 10 digit card number or as part of the card number would be printed.

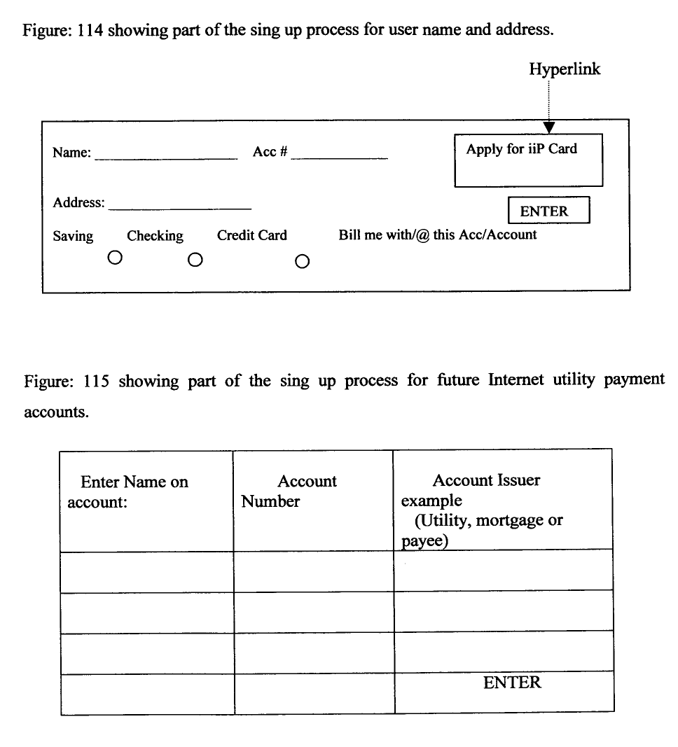

FIG. 114 is a diagram showing part of the sing up process where future user of an account would enter his name and address, method of payment and or apply for an Internet utility payment account (IUPA), by clicking on a hyperlink.

FIG. 115 is a diagram showing part of the sing up process for Internet utility payment where a future user of the account would enter his name, name of his utility and mortgage Company, Landlord name and or other payee name, with the account number of the issuer name. Lfee credit card account holder or user has the option of carrying a secondary card (utility card) with a four-digit number, but can carry 3-10 digits of the account number. The secondary card comes in two flavors, a fix number (Ufix card/utility fix number) that is affix to the utility payment template as shown in FIG. 113 and voluntary number card (VNcard). Both cards are Internet utility payment cards (IUPcards). The cards feed on the primary account, and the primary card is used in person. But the IUPcard can be setup as a separate account, or as an extension (add-on) to conventional credit card, savings or checking account, by using the last four digits of the account number as a Ufix number, VN card or an assign 4 digit, or 3-10 digit number to an existing credit card, saving, checking or other financial account, with access to a limited amount in the account or full access to the total amount in the account see FIG. 110. The utility card is designed for Internet transaction such as rent, utility bills, mortgages and Subscription payments. When used for making ISP payments or subscription payments, each payment is billed three (3) times the amount, e.g. $20 subscription will be billed $60 (quarterly billing) or. Q billing (Q bill) Mortgage card (Lfee m) is setup (issued) against the down payment on the building. How does Lfee secondary card (utility card) work: End user will use a personal software dialog box (dialog template) setup on any computer in order to log into a network web template in the user account. End user can login as the owner or visitor/guest (at home or outside). Using an assign number (PYN/USFIN) and a PIN number or password See FIG. 111. After the account is setup, end user can pay utility bills and or other payee by double clicking the Lfee personal financial software connecter (dialer icon/Link me), which will take him to the Lfee web template as shown in FIG. 112 or 113 depending on the service plan chosen. He will see all of his utility Landlord and mortgage suppliers or payees. The software setup package is architecture to automatically prompt the cardholder ISP dialer to connect to the Internet, directly to the network (Lfee.com). Or you can connect to the Internet with your ISP, then click the minimize button, then double click the Lfee icon. the cardholder can enter his card number e.g. #9111 (VNcard) manually or it can be static on the web template as a Ufix card. In FIGS. 112 and 113 when the words pay with Lfee/IUPcard (Pay W) followed by the payment method that is click/entered, making it an Internet instant payment card (IIPcard) it tells or go to the payee/merchant web site, that a transaction is made/paid e.g. for $23.95, on acc #987 162 2011 or with PYN/card #9111. Then it goes to the payee merchants bank, which links it to the banking systems to verify the card number and or PYN/USFIN authenticity and identify the user by matching the card number with its ABA number hidden in the background. The PYN/USFIN identify the user and the card number identity's the Lender. The card number is like a pointer or extension to the lender ABA number, when pay W is click it also prompts the respectful lender number (transit routing number or ABA #) hidden in the back ground to link with the banking systems. Making general purchase on the web: Cardholder or user will click Lfee (pay with/Pay w), followed by the payment method on the payee web site, which would prompt the Lfee personal software connecter on his computer or other Internet device to automatically popup and connect to the Lfee network. As shown on the left side on FIG. 112. Enter PYN/card number. On the right side he would see the payee name, address, PYN and Lfee license number. When Lfee card is used, merchants only have access to the four digits and or 3 to 10 digits on the card or as part of the card number (Ufix/VN card) and not the account number. Lfee account check amount is link to a conventional checking and or other financial account. A deposit is required to start the account e.g. $5 or 1 to 10% of the credit amount approved. Credsub (Lfee) account is not a 100% credit account, so there is no penalty for accounts that are transfer to such accounts. But an issuer can make a Credsub account 100% credit or credit on the cutting edge (COTCE). The account carry's zero monthly maintenance fees, and has automatic access to the amount allowed for cash advance checks and bonuses. The line of credit must be approved before making the deposit to start the account. Deposit made to start the account is none accessible unless a fee is paid or can be up to 50% of the deposit, depending on the service plan chosen and none interest bearing until the end of the term. Depending on the lender, accounts may have interest bearing as an option, but access to the deposit goes with the service plan. Making purchase with primary Lfee card in person: When the card is swipe or scanned, enter is press to process the card number. The payer photo and signature will automatically appears on the credit card machine or CUPM. After processing with the cash amount, the payer's signature receipt will be printed without his photo and signature would not be printed as an option on the payer's receipt. But the 4 digit and or 3 to 10 digit card number or as part of the card number would be printed.

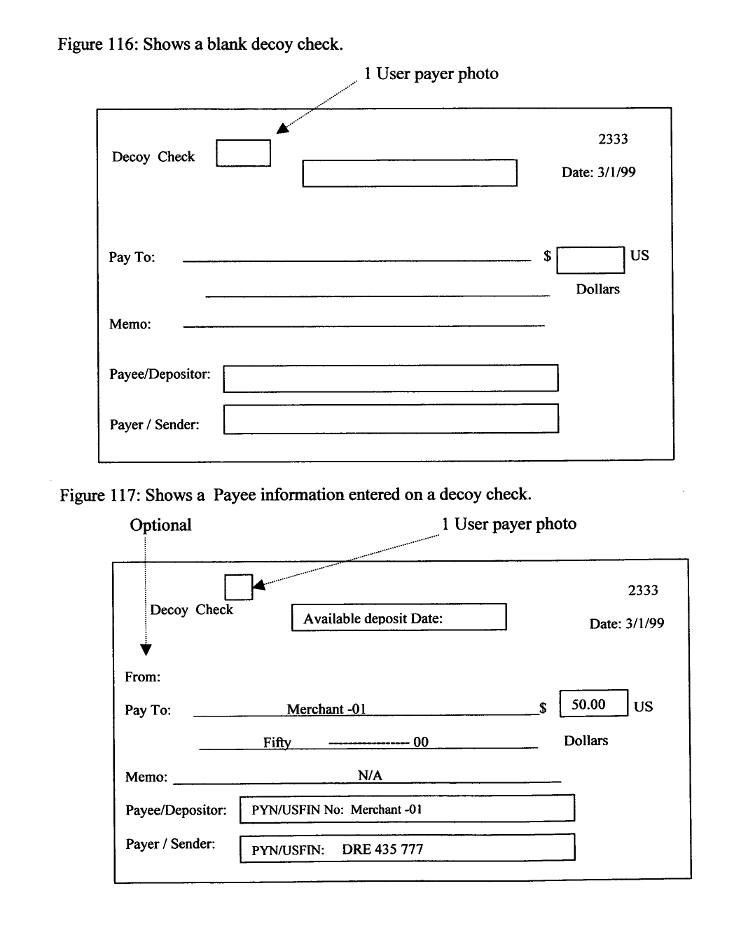

FIG. 116 is a diagram showing a blank decoy check displayed on a portable automated web terminal and or on the web, when access with a decoy check card, paperless electronic check card and or when an account holder or user access the decoy check network remotely. The decoy check network is also access using a password and ID/user name or other advanced method without displaying the a user photo box.

FIG. 117 is an illustrated diagram with number one (1) showing a decoy check, with a payer user photo on a portable automated web terminal or Convenient universal Payment Machine (CUPM) when access by an account user decoy check card, paperless electronic check card and or a paper check with the payee information entered on the decoy check for purchases made in person or over the counter, with the transaction amount, check number 2333, transaction date which is also the date of the written check, payee PYN/USFIN number and payer PYN/USFIN.

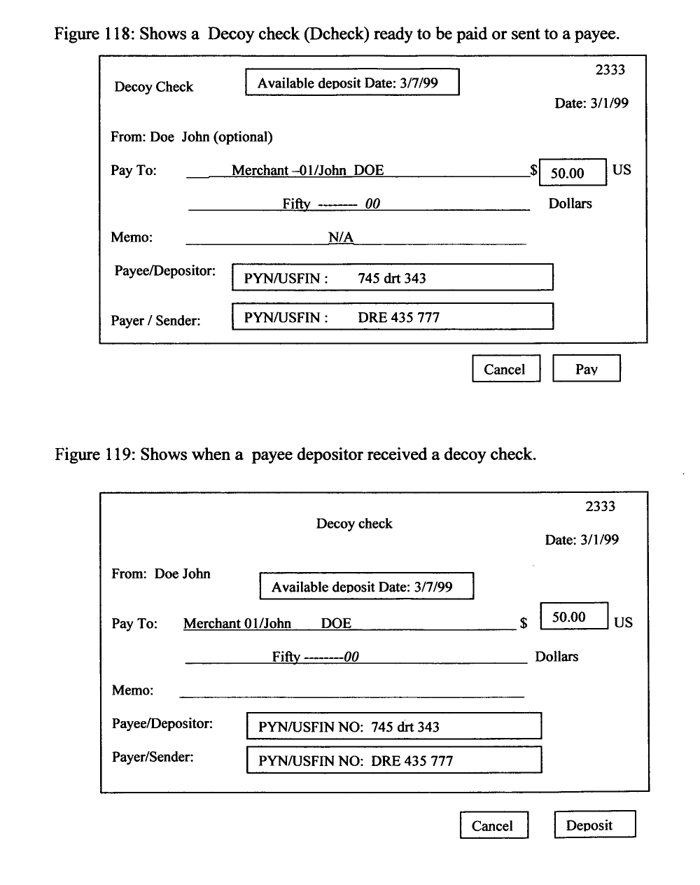

FIG. 118 is a diagram showing a decoy check that is access by using a password and ID/user name or other advanced method with the payee name, amount on the check, PYN/USFIN number, payer PYN/USFIN, check number and the date the decoy check or paperless electronic check would be paid. The check is completed and ready to make a payment. The user or payer has the option to delete the information written on the Decoy check (Dcheck) by clicking cancel or pressing, touching or using other advance method to clear the written information on the displayed Dcheck or can click on pay, submit or send button and or other advanced method that is provided by the decoy check provider or paperless electronic check provider to make the payment or purchase completed. By doing so, the payer sends or move the payee information from the decoy check or paperless electronic check image into the payee receiving or deposit folder onto the payee decoy check or paperless electronic check image where the payee has full control on all received checks available for deposit. Although the payer may press submit, pay or send to, send, the decoy check to the payee, the check does not actually move. Only the information written on the said check that is made available to the payee. What actually happens is, information written on a paid decoy check or paperless electronic check is made available to both the payer paid folder and to the payee receiving folder. Each subscriber user has two folders with at least one check image, a paid or sent folder for making payment or purchase and a receiving or deposit folder to receive and deposit decoy checks or paperless electronic check. The check image also shows that a payer can write a decoy checks or paperless electronic check and send it to a payee and control the said check deposit date means that a payee can received a said check on the eleventh of February, but said check paid date is the seventh of march. A payer can return to his sent or paid folder to change the said check paid date (date funs available) at any time before the paid date and or time said check is allow to be deposit for payment or funs would be available. In as much as all written decoy checks or paperless electronic checks are written by the payer and the so call sent check is in the payer folder, that gives him full control of all checks in his folder and also allowed him to predate the said checks preventing the payee from been able to deposit said checks until the end of the predated said checks expired or available deposit date.

FIG. 119 is an illustrated diagram showing a payee depositor received a decoy check or paperless electronic check image in his receive or deposit check folder with the available deposit Date: Mar. 7, 1999 when the said check would be given access to be deposit. In the event a payee receive a paid said check from a payer and such paid date is not expired or due. The said check cannot be deposit before the expired or due date.

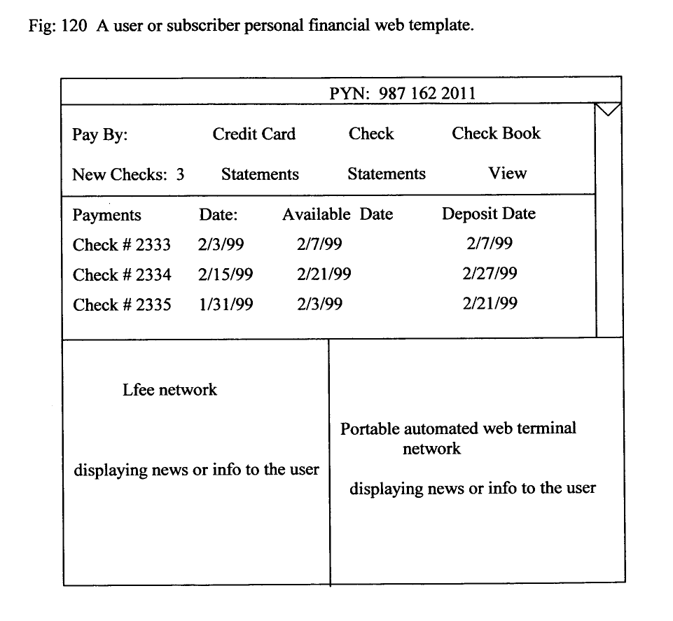

FIG. 120 is showing an illustrated diagram that explaining the invention in it simplest form with a payer/payee or subscriber portable personal financial web template means said web template is a web interface displaying user or subscriber financial accounts after the user log on/in and or gain authentication to get access to the lfee network or portable automated web terminal network. It also shows that the user never have to enter his provider, host, distributor or portable automated web terminal (PAWT) network URL, website address or domain name in order to access the portable automated web terminal (PAWT) network or online services provider network URL in order to log in to a financial account or account. The personal financial web template is embedded in/on the user portable automated web terminal and or architecture on a storage device that is place inside or affix onto a compact portable hand held digital device and a copy of the user subscriber personal financial web template with all of it's activities are save and or reside on the portable automated web terminal network or provider network, said portable digital device display financial accounts and or slave numbers on the user web payment gateway terminal or personal financial web template means that the portable automated web terminal or compact portable hand held digital device gain/get web access when plug into a user computer or direct to the internet means said terminal has a computer adopter to connect to the user computer. As explain in FIG. 119, payee depositor received a decoy check or paperless electronic check template/image in his receive or deposit check folder. The folder reside and or sheltered in a database means that it is deposited and house on the paperless electronic check or paperless decoy check provider network when said check is deposited a copy is also sent to reside and or sheltered on the payee depositor database on his personal financial web template. FIG. 118 also explain that the check template/image does not actually move to the payee depositor folder, the entered/input data or information written on the said check or on the check form means the space or lines on the said check makes it a check forms on the check template/image that is sent and or made available to the payee in/on his check template/image or check form in his received or deposit folder or make the written check in the payer send folder accessible to the payee with the available deposit date when the said check would be given access to be deposit. It also means that the check or transaction originated from a user/payer or subscriber portable personal financial web template on his portable automated web terminal sheltering or containing the payer or user financial account meaning checking account/paperless electronic checkbook, credit card account, saving account that is deposited and resided in/on said personal financial template. The payer has the option of printing a copy of the check that is sent to a payee at anytime from his paperless electronic checkbook and or sent folder, see the deposited date of every sent check and or the date when the payee deposit the check, but that is done from the payer sent folder or in the database that is in s sheltered or house portable financial web template. FIG. 116 also talks of a diagram showing a blank decoy check displayed on a portable automated web terminal and the web means that a payer can write a paperless electronic check or paperless decoy check from his paperless electronic checkbook offline or before login on to the web on his portable financial web template from the portable financial web template menu. The payer enter input data or information on a blank paperless electronic check or paperless decoy check also means that a payer or user using a portable automated web terminal or portable personal web interface plug into a computer to access a network or an online network to enter/input data or information on a form or financial form offline and online.

The present invention has been described with each embodiment. It will be apparent to those skilled in the art would fine various modifications to the embodiment, it is understood that the illustration and example described herein may be combined with other embodiment(s) described herein and has clearly describe the scope and spirit of the invention without limitation.

I claim:

1. A method for subscribing credit, comprising:
a financial computer network to connect subscriber, merchant, payment gateway and or merchant bank to the banking system;
an issuer/lender or bank to issue subscribing credit plan accounts in two flavors subscribing credit card and or subscribing credit checking account wherein a deposit of $5 or up to ten percent of the credit plan is required from the subscriber or user depending on the plan and or issuer/bank or lender zero percent on a subscribing credit plan is an option said deposit part or whole is used by the issuer/bank or lender when there is an outstand balance on a subscribing credit loan or account at the end of the term or working life of a subscribing credit plan or financial account wherein the issuer or lender would use part or whole subscriber deposit to pay off outstanding balance on the subscribing credit debt;
subscribing credit plan or subscribing financial service plan with limited/unlimited working life for subscribers to choose from with a line of credit that does not increase year after year wherein a subscriber line of credit increase when he purchase a higher credit plan or an increase in bonus at an addition fee/cost;
subscriber or user to choose a subscribing credit plan to establish subscribing credit account means to subscribe to/with a lender in exchange for a subscribing credit loan and or using a subscribing credit plan;
subscribing credit card account with a four digit credit card number or an Internet instant payment card/instant Internet payment card (iipcard) or iip card numbers means that the four digit credit card number is reveal after a transaction;
credit account with no cash advance fees when part or whole credit value/amount is used wherein checks are cash on or written from said credit account;
payment/CPAY slip for making payment at any financial institution that issue subscribing accounts;
merchant to provide goods and or services to a subscribing credit account holder with subscribing credit plans;
merchant bank for processing subscribing credit transaction link to a clearinghouse and or the banking system.

2. A method for subscribing credit according to claim 1, wherein said subscriber or user choose a subscribing credit plan to establish a subscribing credit account said account has zero accruing interest with a limited working life wherein an activation fee apply to the account said account is sold and or setup over the counter.

3. A method for subscribing credit according to claim 1, wherein said subscriber or user choose a subscribing credit plan with a limited working life means that an account holder lease the credit from the issuer wherein the life of the subscribing credit loan is valid for or between one to three years wherein the account holder pays a.

4. A method for subscribing credit according to claim 1, wherein said subscriber or user choose a subscribing credit plan that containing or carry bonus means the lender or bank add/give extra available credit to the zero accruing interest account in exchange the lender or bank add interest to the extra available credit or subscribing credit bonus amount when used interest would be added to the bonus section/part of the subscribing credit plan wherein the applicant or subscriber has an existing credit card or other credit account with the issuer/lender or bank said existing credit card or account is in good standing no income check is required on or for the subscriber applicant applying for the credit account wherein the account is issued as a standalone credit card account or credit checking account the issuer would give the subscriber or account a bonus by matching at lest part of the Credsub/credit plan or subscribing credit line with applicant existing or current credit line subscribing credit account required an activation fee to activate said account.

5. A method for subscribing credit according to claim 1, wherein said an issuer/lender or bank to issue subscribing credit plan account subscriber or user choose a subscribing credit plan with or without a bundled service or bundled plan containing subscribing credit card account and or subscribing credit checking account with an account bonus wherein the bonus is a percentage on purchase made with/on the account means the issuer/lender or bank rewarding the subscriber or account user for purchases made with/on said account(s) by putting or depositing its own money into the accountholder account.

6. A method for subscribing credit according to claim 1, wherein said subscriber or user choose a subscribing credit plan contain subscribing checking account wherein a deposit is made to start a subscribing credit checking account said deposit ranging from $5 or up to ten percent of the credit amount apply for or subscribing credit plan with the line of credit approving before a deposit is made wherein deposit made has a none accruing interest with an option of the deposit being none accessible to the account holder until the end of the credit term or working life.

7. A method for subscribing credit according to claim 1, wherein said subscribing credit loan a subscriber with a subscribing credit plan loan having a checking account or credit card account wherein the subscribing credit debt or subscribing credit card/checking account debt is sold by the accountholder means the subscribing credit accountholder transfer his subscribing credit debt to a third party or another subscribing credit lender or issuer wherein subscribing credit accountholder pay's a fee to a subscribing credit lender or credit issuer to lower a credit account interest rate.

8. A method for subscribing credit according to claim 1, wherein said credit account with no cash advance fees when part or whole credit value/amount is used wherein checks written with/from a credit account.

9. A method for subscribing credit as recited in claim 1, wherein said an issuer/lender or bank to issue subscribing credit plan account wherein the subscribing credit plan or account have zero percent on outstanding balance for the life of the subscribing credit loan or subscribing credit account.

10. A method for subscribing credit as recited in claim 1, wherein said outstanding balance at the end of the term or working life of a subscribing credit loan or subscribing credit debt wherein the issuer or lender would use part or whole deposit to pay off outstanding balance in the/an account.

11. A method for subscribing credit as recited in claim 10, wherein said working life of a subscribing credit loan subscriber or user choose a credit plan with the life of the subscribing credit plan expiring within a given time/period or the credit life is limited, is a limited life credit plan.

12. A method for subscribing credit as recited in claim 1, wherein said subscriber or user choose a subscribing credit plan to establish subscribing credit account with subscribing credit checking account or subscribing credit card account that is used for rent transaction means that a lender or bank issue a subscribing credit line with a limited/unlimited working life to a subscriber for the purpose of paying rent to a landlord said account is a rent card account wherein the utility card is designed for Internet transaction for rent, utility bills and or subscription payments with Q billing.

13. A method for subscribing credit as recited in claim 1, wherein said outstanding balance account having an outstanding balance at the end of the month over $50 two to five percent of the outstanding balance is due plus the subscribing fee wherein a balance having under $50 twenty five to fifty percent of said balance is due plus the subscribing fee.

14. A method for subscribing credit as recited in claim 1, wherein said subscriber or user to choose a subscribing credit plan to establish a subscribing credit account with a lender said subscriber or user pay a monthly subscribing fee to use the credit means subscriber or user pays a monthly user or service fee for the life of a subscribing credit loan or subscribing credit plan account.

15. A method for subscribing credit as recited in claim 1, wherein said subscribing credit accounts in two flavors means issuer/lender or bank issuing subscribing credit card and or subscribing credit checking account to users with a subscribing credit plan is a credit leasing account wherein a subscriber using a subcred (subscribing credit) credit plan with an out house lender to pay off charges on the subcred account wherein the subscribing credit plan is link with a regular credit card or another financial account wherein account holder write a check for $100 when the account has a $25 balance the account issuer will pay the other $75 or $100 and charge it to account holder conventional credit card or other financial account that is link to the said account to avoid returned or bounce checks wherein a credit card holder used part or whole existing credit card account to establish a subscribing credit account or a issuer using part or whole credit card account to establish subscribing credit plan account.

16. A method for subscribing credit as recited in claim 1, wherein said subscribing credit accounts line of credit does not increase year after year an increase in a subscribing credit line occur when an account holder purchase additional (more) credit to move to a higher subscribing credit plan for a fee or with an additional cost depending on the account provider.

17. A method for subscribing credit as recited in claim 1, wherein said subscribing credit card and or subscribing credit checking account means a financial account using a card and or check to make purchase or payment wherein a percentage of all purchase and or payment made from a subscribing credit card account and or subscribing credit checking account with said card or check used for said account is put/place aside or back into the user account is a bonus from said account issuer/lender or subscribing credit loan purchase and or payment reward bonus wherein at the end of the term or account working life there is an outstand balance in/on the account it will be used as a payment towards the account wherein no outstanding balance is/on the account it becomes void automatically if not used within a given time or period by the account holder or subscriber.

18. A method for subscribing credit as recited in claim 1, wherein a Payment/CPAY slip for making payment at a financial institution that issues Credsub/subscribing credit or financial accounts wherein the financial institution did not issued the subscriber or payer account wherein the subscriber or payer using his issuer routing number, four digit credit card account number to make payment for said subscribing account.

19. A method for subscribing credit as recited in claim 1, wherein iipcard numbers are distributed on loose paper cards and or tear off from in a set said iipcard is use in internet transaction by entering the iipcard number manually on the payee payment gateway said iipcard means a credit card when used with/for ISP billing or a subscribing account would be automatically billed three times the total posted or displayed cash value for the product/services with a single use wherein all the iipcard numbers are used up on a single card the subscriber would move on to another or new card from the set.

20. A system for subscribing credit, comprising:
financial computer network to connect subscriber, merchant, merchant bank and or subscribing account provider;
an issuer/lender or bank to issue subscribing credit plan accounts in two flavors, subscribing credit card and or subscribing credit checking account;
subscribing credit plan or subscribing financial service plan with limited/unlimited working life for subscribers to choose from;
subscribers or users to choose subscribing credit plan to establish subscribing credit account means to subscribe to/with a lender in exchange for a subscribing loan and or using a subscribing credit plan;
subscribing credit card account with a four digit credit card number or Internet instant payment card/instant Internet payment card (iipcard) or iip card numbers;
subscribing credit checking account with no cash advance fees when part or whole credit value/amount is used;
a payment/CPAY slip for making payment at any financial institution that issue subscribing accounts;
a merchant to provide goods and or services to a subscribing credit account holder with subscribing credit plans;
a merchant bank for processing subscribing credit transaction to link to a clearinghouse or banking system.
